(19) United States
(12) Patent Application Publication
(10) Pub. No.: US 2015/0190788 A1
(43) Pub. Date: Jul. 9, 2015

(54) Selective Catalytic Deoxygenation of Biomass and Catalysts Therefor

(71) Applicant: Albermarle Europe SPRL, Louvain-la-Neuve (BE)

(72) Inventors: Milena Vasic, Oegstgeest (NL); Melle Koch, Amsterdam (NL); Martinus Henricus Pronk, Amstelveen (NL); Leonardus Cornelis Albertus van den Oetelaar, Haarlem (NL); Ruben van Duren, Hilversum (NL)

(21) Appl. No.: 14/417,725

(22) PCT Filed: Aug. 7, 2013
(86) PCT No.: PCT/EP2013/066532

§ 371 Date: Jan. 27, 2015

Related U.S. Application Data
(60) Provisional application No. 61/681,064, filed on Aug. 8, 2012.

(51) Int. Cl. B01J 23/847; B01J 37/02; B01J 37/08; C10B 57/06; B01J 23/10; B01J 23/78; B01J 23/28; B01J 23/34; B01J 23/00; B01J 23/83

(52) U.S. Cl. CPC B01J 23/8474; B01J 23/007; B01J 37/0213; B01J 37/08; B01J 23/83; B01J 23/10; B01J 23/78; B01J 23/28; B01J 23/34; C10B 57/06

(57) ABSTRACT

This invention provides new, effective pyrolysis catalysts adapted for use in pyrolysis of biomass, to the preparation of such catalysts, and to the use of such catalysts in the pyrolysis of biomass in the absence of added air, added molecular oxygen, and added molecular hydrogen, and liquids such as water. The catalysts are layered HTCs and related materials which are impregnated with specified pairs of metals, which impregnated layered HTCs and related materials have been calcined in air at elevated temperatures.

### TECHNICAL FIELD

This invention relates to new, effective pyrolysis catalysts adapted for use in pyrolysis of biomass, to the preparation of such catalysts, and to the use of such catalysts in the pyrolysis of biomass in the absence of any of added air, added molecular oxygen, added molecular hydrogen, and/or added liquids such as water.

### BACKGROUND

Despite extensive research over the years, there still exists the problem of effectively catalytically pyrolyzing biomass to form selectively focused pyrolysis fluids enriched in hydrocarbons and/or hydrocarbon precursors. In attempts to improve the pyrolysis products and processes, use of lower pyrolysis temperatures with or without addition of water or hydrogen has been proposed. It has been found in our laboratories that unfortunately, at least in the absence of water or hydrogen, use of lower temperatures has increased substantially the amount of carbon converted into coke, thereby resulting in extremely low efficiency of the process with respect to carbon content. This in turn has a detrimental effect upon usefulness of the pyrolysis process for producing hydrocarbonaceous transportation fuels because of the reduced yields of hydrocarbonaceous products produced.

### SUMMARY OF THE INVENTION

It has now been found possible during pyrolysis of suitable types of biomass to catalytically focus, direct, or steer pyrolytic deoxygenation in certain selected directions. This in turn enables formation of gaseous products (carbon monoxide, carbon dioxide, and water) enriched in various ways. Additionally, pyrolysis oils can be produced having improved properties such as lower acidity, lower oxygen content, reduced corrosiveness, and desired carbon/hydrogen ratios. Consequently, less post-treatment of pyrolysis oil is required and better compatibility/miscibility with fossil fuels is achieved because of reduced amounts of oxygen-containing polar compounds in the pyrolysis oil.

This invention makes possible the achievement of these advantages by providing, inter alfa, methods of pyrolyzing solid state biomass material to produce pyrolysis oils and mixtures of gaseous CO, CO₂, and/or H₂O having improved characteristics. Such methods comprise:
(I) forming a mixture by bringing into contact under agitation in a pyrolysis reactor:
   A) particulate or subdivided solid state biomass material which is untreated except for optional drying and/or size reduction;
   B) an impregnated or doped solid state calcined pyrolysis catalyst which as charged (i.e., just before being charged) to the reactor is a calcined product comprising, consisting essentially of, or consisting of at least one calcined hydrotalcite or hydrotalcite-like compound, layered dihydroxide, anionic clay, or a mixture of any two or more of them, impregnated or carrying (1) a single pair of metals, (2) at least one oxide of each of a single pair of metals, or (3) a combination of (a) at least one oxide of one or both of a single pair of metals and (b) at least one free metal of one or both of a single pair of metals, wherein said calcined product is formed by calcining at least one pre-calcined hydrotalcite or hydrotalcite-like compound, layered dihydroxide, anionic clay, or a mixture of any two or more of them, that has been impregnated by or carries salts of said pair of metals, in the presence of free oxygen (e.g., air or a mixture of oxygen and at least one inert gas selected from nitrogen, neon, argon, or krypton), and wherein the single pair of metals of (1), (2), or (3) is selected from the following groups: Ca & Ce, Ca & Cu, Ca & Fe, Ca & Mn, Ca & Y, Ca & Zn, Ce & Fe, Ce & Ni, Ce & Y, Cu & Nb, Fe & Y, Mo & Zn, Mn & Y, Ni & Y; and
   C) a solid state particulate heat carrier;
(II) fast or flash pyrolyzing at one or more temperatures above about 500° C. at least a portion of said mixture of (I) within the pyrolysis reactor and in the absence of (without) any of added air, added molecular oxygen, added molecular hydrogen, and/or added liquid diluent or carrier such as water to thereby form fluid pyrolysis products. In other words, none of the following is added: (i) air, (ii) molecular oxygen, (iii) molecular hydrogen, (iv) liquid diluent such as water.
   Each such method using an individual catalyst identified in (I) B) above constitutes an individual embodiment of this invention. The foregoing method makes possible the formation of fluid pyrolysis products comprising (1) pyrolysis oil of improved quality and/or enriched in hydrocarbon content, and/or (2) a gaseous phase selectively enriched in carbon monoxide or carbon dioxide or water, or a mixture of any two or all three of carbon monoxide, carbon dioxide, water.

As used herein, including the claims, the term “rehydrated” in the phrase “rehydrated impregnated or doped solid state calcined pyrolysis catalyst” means that the rehydration, which activates the catalyst, is conducted at any suitable stage of catalyst preparation before the final calcination step that completes the formation of the catalyst composition.

It is to be understood and appreciated that whenever the word “catalyst” is used, the substance referred to is to be considered a catalyst precursor because, in use, it (the “catalyst”) is exposed to other materials under various reaction conditions. Thus, although as charged to the reactor, it (the “catalyst”) comprises, consists essentially of, or consists of a calcined product formed from components (1), (2), or (3) of (B) above impregnated or carried on at least one hydrotalcite or hydrotalcite-like compound, layered dihydroxide, anionic clay, or a mixture of any two or more of them, it (the “catalyst”) may undergo chemical changes under the particular reaction conditions existing in the pyrolysis reactor.

The terms, “hydrotalcites”, “hydrotalcite-like compounds”, “layered dihydroxides”, and “anionic clays” are regarded in the art as alternative expressions for a well-recognized category of products. Indeed various other names have been applied in the art to these materials, such as lamellar double hydroxides and anionic clays. See in this connection Chapter 1 of Rives, V.; Ed. “Layered Double Hydroxides: Present and Future”, Nova Science Publishers, Inc., New York, 2001. Since these substances are well known and thoroughly described and characterized in the art, anyone desiring further information concerning such substances has ample source material available to understand the natural and synthetic materials useful in the practice of this invention. Other useful sources of such information are F. Cavani et al. “Hydrotalcite-Type Anionic Clays: Preparation, Properties and Applications”, Catalysis Today, 11 (1991) Elsevier Science Publishers B. V. Amsterdam; and J P Besse et al. Anionic Clays: Trends in Pillary Chemistry, its Synthesis and Microporous Solids (1992), 2, 108, editors: M. I. Occelli, H. E. Robson, Van Nostrand Reinhold, N.Y. For convenience the term “hydrotalcite or hydrotalcite-like compound”, or “HTC”, whether in the singular or plural, is generally used in this document to represent the entire category of substances (hydrotalcites, hydrotalcite-like compounds, layered dihydroxides, and anionic clays). To the extent to which these materials may differ, if any, mixtures thereof may be used. Natural and synthetic hydrotalcites are included in this category although synthetic “HTCs” are generally preferred. More preferably, the HTC used is a synthetic hydrotalcite in which the two metals forming the oxides thereof are magnesium and aluminum.

In conducting the pyrolysis methods referred to above, the operation is conducted under fast or flash pyrolysis conditions. Thus, the temperature is elevated from ambient up to and above 500° C. and preferably no higher than about 650° C. at a rate of at least 100° C. per second. Another way of achieving fast or flash pyrolysis is to conduct the operation so that the average residence time of the pyrolysis products within the pyrolysis reactor is very short, typically is 30 seconds or less, preferably 20 seconds or less, or more preferably 10 seconds or less. Depending upon the reactor design and auxiliaries employed, even shorter average residence times are possible. Ordinarily, pyrolysis temperatures above about 700° C. are rarely used. Desirably, the maximum pyrolysis temperature used in this invention is about 650° C. and preferably is no more than about 575° C. Desirable and preferred temperature ranges are from above 500° C. to about 600° C. and in the range of about 510° C. to about 575° C. at substantially atmospheric pressure. Reactors which can be used include fluid bed reactors, auger reactors, bubble reactors, or the like. Of these, a fluid bed reactor has been found to give very good results. If desired, the pyrolysis products can be quenched with a suitable liquid such as water immediately upon removal from the pyrolysis reactor.

In a desirable mode of operation, the pyrolysis is conducted at substantially atmospheric pressure and the solid state biomass material is carried into the pyrolysis reactor in a flow of inert anhydrous carrier gas such as dry nitrogen or other inert anhydrous carrier gas such as neon, argon, or krypton.

The amount of the two metals of the additive pair (calculated as metals) as distinguished from the amount of HTC in the resultant catalyst composition after calcination can vary but typically is in the range of about 1 to about 10 wt % and preferably in the range of 4 to about 9 wt %, these percentages being based on the total weight of the calcined composition. The atomic ratio of the two metals to each other (again calculated as metals) of the additive pair in the impregnated and calcined HTC catalyst composition is typically in the range of about 1:15 to about 15:1, and preferably is in the range of about 1:7 to about 7:1, more preferably in the range of about 1:3 to about 3:1.

As used throughout this document, the terms “solid state biomass”, “solid biomass”, “biomass” and “biomass material” are sometimes used to refer to the “solid state biomass material”.

Although various types of solid state biomass material can be used, lignocellulosic biomass is a preferred type of biomass material for use in the pyrolysis methods of this invention. One representative lignocellulosic biomass contains approximately 45 wt % carbon, approximately 6 wt % hydrogen, and approximately 49 wt % oxygen, but other similar lignocellulosic biomass materials are deemed equally representative and preferable for use.

Of the solid state particulate heat carriers (sometimes referred to as heat transfer agents) that can be used, sand (e.g., silica sand) is plentiful and very effective. Other materials such as volcanic ash, crushed rock, pulverized concrete, etc., can be used if desired. Mixtures of different solid state particulate heat carriers can be used if desired.

Pursuant to another embodiment of this invention there are provided solid state pyrolysis catalyst compositions adapted for selectively directing the pyrolysis of solid state biomass materials toward the formation of pyrolysis oils enriched in hydrocarbons and away from the formation therein of oxygenated products and/or pyrolysis oils having improved properties; and/or formation of pyrolysis gases selectively enriched in one or more of CO, CO₂, and/or H₂O. These new catalysts in the form as charged (i.e., just before being charged) to the reactor comprise, consist essentially of, or consist of, a calcined catalyst formed from at least one catalyst precursor comprising, consisting essentially of, or consisting of at least one pre-calcined hydrotalcite or hydrotalcite-like compound, layered dihydroxide, anionic clay, or a mixture of any two or more of them, impregnated with or carrying salts, preferably inorganic salts, of a pair of metals selected from the following groups: Ca & Ce, Ca & Cu, Ca & Fe, Ca & Mn, Ca & Y, Ca & Zn, Ce & Fe, Ce & Ni, Ce & Y, Cu & Nb, Fe & Y, Mo & Zn, Mn & Y, Ni & Y. The calcination of the catalyst precursor is conducted in the presence of free oxygen (e.g., air or a mixture of oxygen and at least one inert gas selected from nitrogen, neon, argon, or krypton) so that one or more oxides of at least a portion of one or both of the pair of metals are converted into oxides. Each calcined catalyst referred to in this paragraph constitutes an individual embodiment of this invention.

The catalysts of this invention are formed from HTC which is typically represented by the general formula

[M^{II}₍₁₋ₓ)M^{III}ₓ(OH)₂]^{x+}[A^{II-}]_{x/n}*mH₂O

where M^{II} is a divalent metal such as Mg²⁺, Co²⁺, Ni²⁺, Zn²⁺, etc., M^{III} is Al³⁺, Cr³⁺, Ga³⁺, Fe³⁺; and A^{II-} is an organic and/or inorganic ion. See, for example, Chapter 11, entitled Hydrogenation Catalysis by Mixed Oxides Prepared from LDHs, by A. Monzon et al. which is in Rives, V., Editor. Layered Double Hydroxides: Present and Future, Nova Science Publishers, Inc., New York, 2001; Valente et al., Layered Double Hydroxides: Properties, Applications and Synthetic Procedures, SciTopics, Retrieved Jan. 6, 2012.

Still another embodiment of this invention is a method of preparing a catalyst composition adapted for producing pyrolysis products in the absence of any added air, molecular oxygen, molecular hydrogen, or liquid such as water, from particulate or subdivided solid state biomass material which is untreated except for optional drying and/or size reduction. The method of preparing the catalyst composition comprises:
A) producing or providing one or more solutions (typically one solution or two separate solutions), which taken individually provides or which taken collectively provide, a dissolved selected pair of metals, the solvent(s) of such solution(s) which can be the same or different, being vaporizable solvent(s), preferably water, and the metal contents of said one or more solutions is a pair of dissolved metals selected from the group consisting of Ca & Ce, Ca & Cu, Ca & Fe, Ca & Mn, Ca & Y, Ca & Zn, Ce & Fe, Ce & Ni, Ce & Y, Cu & Nb, Fe & Y, Mo & 7n, Mn & Y, and Ni & Y; and
B) impregnating a (pre-calcined) powdery or particulate hydrotalcite or hydrotalcite-like compound, layered dihydroxide, anionic clay, or a mixture of any two or more of them, by incipient wetness using one or more of said solutions of A) above to form a wet mixture, drying the resultant wet mixture to form a product mixture, and then calcining the product mixture in the presence of free oxygen (e.g., in air or in a mixture of oxygen and at least one inert gas selected from nitrogen, neon, argon, or krypton). This calcination of the dried mixture converts the salts of the selected pair of metals into oxides of such metals, with the optional co-presence of free metal(s) corresponding to one or both of the pair of dissolved metals of said one or more solutions of A) above.
   Each of the above methods of preparing an individual catalyst precursor as in A) above, constitutes an individual embodiment of this invention. In reference to the absence of added air, molecular oxygen, molecular hydrogen, or liquid such as water, it is understood that adventitious amounts of air, molecular oxygen, molecular hydrogen, or liquid such as water may be present, e.g., from the biomass material.

Further embodiments of this invention are: a method for converting solid state biomass material into at least

AA) one or more fluid hydrocarbon products, which method comprises introducing particulate or subdivided solid state biomass material which is untreated except for optional drying and/or size reduction into a reactor operating at a temperature(s) above about 500° C. under fast or flash operating conditions, said reactor containing a fluidized mixture of:
(1) a calcined pyrolysis catalyst which as initially introduced into the reactor is a catalyst formed by a method comprising:
   A) producing or providing one or more solutions (typically one solution or two separate solutions), which taken individually provides or which taken collectively provide, a dissolved selected pair of metals, the solvent(s) of such solution(s) which can be the same or different, being vaporizable solvent(s), preferably water, and the metal contents of said one or more solutions is a pair of dissolved metals selected from the group consisting of Ca & Ce, Ca & Cu, Ca & Fe, Ca & Mn, Ca & Y, Ca & Zn, Ce & Fe, Ce & Ni, Ce & Y, Cu & Nb, Fe & Y, Mo & Zn, Mn & Y, and Ni & Y; and
   B) impregnating a (pre-calcined) powdery or particulate hydrotalcite or hydrotalcite-like compound, layered dihydroxide, anionic clay, or a mixture of any two or more of them, by incipient wetness using one or more of said solutions of A) above to form a wet mixture, drying the wet mixture to form a product mixture, and then calcining the product mixture in the presence of free oxygen (e.g., in air or in a mixture of oxygen and at least one inert gas selected from nitrogen, neon, argon, or krypton); and
(2) a solid state particulate heat carrier;
   wherein the pyrolysis is conducted in the absence of any of added air, any added molecular oxygen, any added molecular hydrogen, or any added liquid diluent or carrier such as water. Fluid pyrolysis products are thereby formed.

AB) A method of AA), wherein said pair of metals is selected from Ca & Ce, Ca & Cu, Ca & Fe, Ca & Mn, Ca & Y, Ca & Zn, Fe & Y, Mo & Zn, and Mn & Y.

AC) A method of AB), wherein said pair of metals is selected from Ca & Cu, and Ca & Fe.

AD) The methods of any of AA), AB), or AC), wherein the metal content of said pre-calcined hydrotalcite or hydrotalcite-like compound, layered dihydroxide, anionic clay, or a mixture of any two or more of them, is magnesium and aluminum.

AE) The methods of any of AA), AB), or AC), wherein said fast or flash operating conditions include temperatures from above 500° C. to about 650° C. at substantially atmospheric pressure, wherein the biomass material is charged into the pyrolysis reactor with an inert anhydrous carrier gas, preferably nitrogen, argon, neon, or krypton, or a mixture of any two or more thereof, wherein said a solid state particulate heat carrier is sand, wherein the average particle size of said calcined pyrolysis catalyst as charged to the reactor is in the range of about 40 to about 400 microns, and preferably in the range of about 50 to about 150 microns, wherein said calcined pyrolysis catalyst as charged into the pyrolysis reactor has been activated by rehydration, and wherein the average residence time within the pyrolysis reactor is 30 seconds or less, preferably 20 seconds or less, and more preferably 10 seconds or less.

AF) The methods of any of AA), AB), or AC), wherein the metal content of said pre-calcined hydrotalcite or hydrotalcite-like compound, layered dihydroxide, anionic clay, or a mixture of any two or more of them, is magnesium and aluminum, wherein said fast or flash operating conditions include temperatures from above 500° C. to about 650° C. at substantially atmospheric pressure, wherein the biomass material is charged into the pyrolysis reactor with an inert anhydrous carrier gas, preferably nitrogen, argon, neon, or krypton, or a mixture of any two or more thereof, wherein said a solid state particulate heat carrier is sand, wherein the average particle size of said calcined pyrolysis catalyst as charged to the reactor is in the range of about 40 to about 400 microns, and preferably in the range of about 50 to about 150 microns, wherein said calcined pyrolysis catalyst as charged into the pyrolysis reactor has been activated by rehydration, and wherein the average residence time within the pyrolysis reactor is 30 seconds or less, preferably 20 seconds or less, and more preferably 10 seconds or less.

For convenience the catalysts comprised of HTCs which have been suitably impregnated with pairs of metals and/or metal salts and calcined at one or more suitable elevated temperatures are sometimes referred to herein as “bimetallic catalysts of this invention”. It is to be understood that the term “bimetallic catalysts of this invention” does not mean that the two different metals or different metal pairs are in only metallic form. Instead this term means that as charged (i.e., just before being charged) to the reactor there are two metallic elements present in the pair of metals and either or both of these can be in part or in whole in the form of one or more oxides, since the bimetallic catalysts of this invention are calcined in air or free oxygen-containing inert gas such as nitrogen, argon, neon, or krypton, at one or more suitably high elevated temperatures prior to being used. In short, free metals and/or one or more oxides of either or both of such metals of the pair can be present as an impregnated coating on the bimetallic catalysts of this invention.

In each of the embodiments described above, the average particle size of the bimetallic catalysts of this invention desirably falls in the range of about 40 to about 400 microns, and preferably in the range of about 50 to about 150 microns.

Calcination temperatures used in forming the bimetallic catalysts of this invention can vary. Typically, suitable calcination temperatures are in the range of about 550° C. to about 800° C. Preferred temperatures are in the range of about 575° C. to about 700° C. Temperatures in the range of about 575° C. to about 625° C. such as 600° C. are more preferred.

The above calcination temperatures are also suitable for use in pre-calcining the hydrotalcite or hydrotalcite-like compound, the layered dihydroxide, the anionic clay, or the mixture of any two or more of them used in forming the bimetallic catalysts of this invention.

The above and other features, embodiments, and/or advantages will become still further apparent from the ensuing description, appended claims, and accompanying drawings.

### BRIEF DESCRIPTION OF THE DRAWINGS

FIG. 1 is a bar chart showing the results obtained in pyrolysis experiments in which, using the bench scale method of catalyst preparation, a variety of HTCs impregnated or doped with a pair of metals and calcined after drying were tested for effectiveness in producing CO and CO₂ via fast pyrolysis at 515° C.

FIG. 2 is a bar chart showing the results obtained in pyrolysis experiments in which, using Catalyst Preparation Method A or B, a variety of HTCs impregnated or doped with a pair of metals and calcined after drying were tested for effectiveness in yielding water on pyrolysis.

FIG. 3 is a side view in section of a preferred semi-adiabatic fluid bed performance test apparatus which enables rapid evaluation of the performance of fluidizable catalyst compositions with respect to acidity of, and oxygen removal from, pyrolysis oil products produced using such catalyst compositions pursuant to this invention.

### FURTHER DETAILED DESCRIPTION OF THE INVENTION

This invention provides, among other things, methods for solid state biomass conversion in which solid state biomass material (such as lignocellulosic biomass or other biomass materials, especially those derived from land-based sources and that have the potential of providing substantial amounts of hydrocarbons on pyrolysis) is converted in a single reaction step to a product enriched in hydrocarbons and in at least one and preferably more than one hydrocarbon precursor (i.e., carbon monoxide, carbon dioxide, and/or water). This is accomplished by conducting a pyrolysis, especially a fast pyrolysis, of a suitable solid state biomass material in the absence of any added air, molecular oxygen, molecular hydrogen, molecular ozone, and liquid such as water, at one or more suitably high reaction temperatures using a catalyst of this invention.

A wide range of biomass feedstocks of various types, sizes, and moisture contents can be utilized in the practice of this invention. The solid state biomass material feedstock can include one or more materials selected from fast-growing woods (e.g., willow and poplar), timber harvesting residues or forestry waste material, softwood chips, hardwood chips, tree branches, tree stumps, leaves, bark, sawdust, off-spec paper pulp, agricultural waste material, corn, corn stover, wheat straw, rice straw, sugarcane bagasse, switch grass, municipal waste, commercial waste, grape pumice, almond shells, pecan shells, coconut shells, coffee grounds, grass pellets, hay pellets, wood pellets, cardboard and paper. Cellulosic biomass material may be used as well. However, it has been found that such materials tend to form sticky residues during pyrolysis. Thus careful temperature control and frequent cleaning of the pyrolysis reactor and related materials such as agitators, etc. are recommended when using cellulosic biomass material. Generally speaking, lignocellulosic biomass materials and analogous materials capable on pyrolysis of providing substantial amounts of hydrocarbons are preferred for use. Such materials may be processed on a batch, semi-batch or continuous basis, as desired.

In alternative embodiments, the cellulosic biomass material is formed by land-based plants. Land-based plants virtually without exception form a combination of lignin and cellulose, commonly referred to as lignocellulosic biomass. Although food crops can be used for use in the process of the present invention, it is economically and ethically referred to use energy crop material, agricultural waste material, or forestry waste material. Examples of suitable energy crop materials include switch grass and fast-growing woods, such as willow and poplar.

Optional pretreatment of the selected solid state biomass material pursuant to this invention is limited to two types of pretreatment. One such pretreatment is to pre-dry the biomass material prior to use in the pyrolysis. This can be accomplished by application of heat, storage under suitable temperature conditions for suitable lengths of time, use of blow drying or other similar air drying techniques, and the like. The other pretreatment is to reduce to the size of the biomass material before its use in the pyrolysis. This typically involves a suitable mechanical treatment such as milling, grinding, kneading, chopping, sawing, or other physical methods of size reduction, or a combination thereof.

As noted above, the catalysts of this invention used in effecting the pyrolysis are one or more powdery or particulate HTCs which, as introduced into the pyrolysis vessel, carry or are doped with a coating of a pair of particular metals and/or one or more oxides of either or both of the pair of metals.

The principal functions of the catalyst systems used pursuant to this invention with any selected suitable solid state biomass material are to catalytically focus, direct, or steer pyrolytic deoxygenation in certain selected directions whereby advantageous results are obtained in the pyrolytic processing or in the quality of the fluid products (gases and liquids) formed in the process, or both.

In all of the pyrolysis methods of this invention, in all of the bimetallic catalysts of this invention, and in all of the methods of preparing a bimetallic catalyst of this invention, the preferred pairs of additive metal components used in impregnating or doping the precalcined HTC are water-soluble compounds (e.g., salts, oxides, or hydroxides) of the following 9 individual metallic pairs: Ca & Ce, Ca & Cu, Ca & Fe, Ca & Mn, Ca & Y, Ca & Zn, Fe & Y, Mo & Zn, and Mn & Y. The combination of Ca & Cu is particularly preferred, as is the combination of Ca & Fe. These bimetallic catalysts of this invention are not only formed by impregnation by desirable paired metal additive components (typically salts) onto a substrate, and the impregnated substrates are thereafter calcined to form metal and/or metal oxide catalytic surfaces, but additionally, the substrates are pre-calcined hydrotalcites or hydrotalcite-like compounds, layered dihydroxides, anionic clays, or mixtures of any two or more of them, that have been formed by a process comprising the steps of
(a) milling or otherwise size-reducing a physical mixture of a divalent metal compound and a trivalent metal compound,
(b) calcining the milled or otherwise size-reduced physical mixture at a temperature in the range 200-800° C., and
(c) rehydrating the calcined mixture in aqueous suspension, wherein an additive pair is present in the physical mixture and/or the aqueous suspension of step (c).
   This process, which serves to activate a catalyst composition in very small particle form but without use of the particular additive combinations of this invention, is described in Jones et al., U.S. Published Patent Application No. U.S. 2008/0032884, published Feb, 7, 2008. For convenience, this process involving steps (a), (b), and (c) is sometimes referred to hereinafter as “the catalyst activation process”. In this process, the term “physical mixture” refers to a mixture of the compounds of (a), either in a dry or aqueous state, which compounds have not reacted with each other to any significant extent before calcination. Thus, the physical mixture has not been aged to form a pre-calcined hydrotalcite or hydrotalcite-like compound, layered dihydroxide, anionic clay, or a mixture of any two or more of them before calcination.

Accordingly, bimetallic catalysts having any of the 9 metal pairs referred to in the immediately preceding paragraph have desirable metal and/or metal oxide impregnated surfaces, and preferably also have been activated by rehydration in accordance with the catalyst activation process described in the immediately preceding paragraph. Most preferably, the metal content of these pre-calcined hydrotalcites or hydrotalcite-like compounds, layered dihydroxides, anionic clays, or mixtures of any two or more of them is magnesium and aluminum.

### Illustrative Catalyst Preparation Procedures

In order to illustrate suitable procedures for preparing the bimetallic catalysts of this invention, three different catalyst preparation methods were employed. Two such methods involved robotic plate impregnation using robot instruments.

In the first such method (hereinafter referred to sometimes as Catalyst Preparation Method A, Mg/Al/HTC powder (125-400 microns) was deposited on a plate. The required amount of impregnation solution in a vial is spread all over the support catalyst (HTC) surface in the form of small droplets totaling 49 droplets. Then the catalyst was allowed to stand with the impregnation solution for a period of 30 minutes. The wet powder was well mixed and then calcined in air at 600° C. during a period of 90 minutes with a temperature ramp of 5° C. per minute. The impregnation solutions used in this operation were metal nitrates using two metals as metal oxide precursors in the solution used for impregnation with a bimetallic content.

The second method (hereinafter referred to sometimes as Catalysts Preparation Method B involved robotic shaking impregnations using a commercially available instrument manufactured for this purpose. In this method, 1.6 g of HTC was put in a tube. The required amount of one of the two metal precursors and/or metal oxide precursors was added along with the amount of water calculated using the pore volume of the HTC. Using the robot instrument in a rotating/vibrating mode, the impregnation commenced according to the incipient wetness technique. The resultant product was dried in the tube at 120° C. for one hour. This procedure was repeated using the second metal and/or metal oxide precursor. After drying, the dried product was then calcined at 600° C. for 90 minutes with a temperature ramp of 5° C. per minute.

For larger laboratory scale catalyst preparation, the following third method (hereinafter referred to sometimes as Method C or as the “bench scale method”) was used for impregnations and catalyst formation. Each preparation provided about 60 g of catalyst. Into a large flask was placed about 120 grams of sieved HTC. The impregnation solution was formed by mixing the required amount of the first metal and/or metal oxide precursor with the minimum of water calculated from the pore volume of the HTC, and followed by incipient wetness with the impregnation solution, including shaking of the wet mixture followed by drying at 100° C. for 5 hours. In order to prepare a mixture of two metal and/or metal oxide precursors, this method was repeated for impregnation with the second precursor. After the second drying was finished, calcination was conducted at 600° C. As noted previously, the catalyst activation process described above is preferably used in forming the pre-calcined hydrotalcites or hydrotalcite-like compounds, layered dihydroxides, anionic clays, or mixtures of any two or more of them, especially when the additive pairs are selected from Ca & Ce, Ca & Cu, Ca & Fe, Ca & Mn, Ca & Y, Ca & Zn, Fe & Y, Mo & Zn, and Mn & Y. Another advantage of using the catalyst activation process is that the milling or other size-reducing step used therein provides a catalyst with desirably small particle size typically in the range of 40 to 400 microns, and preferably 50 to 150 microns. For still larger catalyst preparations, conventional large scale impregnation and/or doping catalyst preparation procedures are known in the art and can be employed.

### Catalyst Testing Procedures

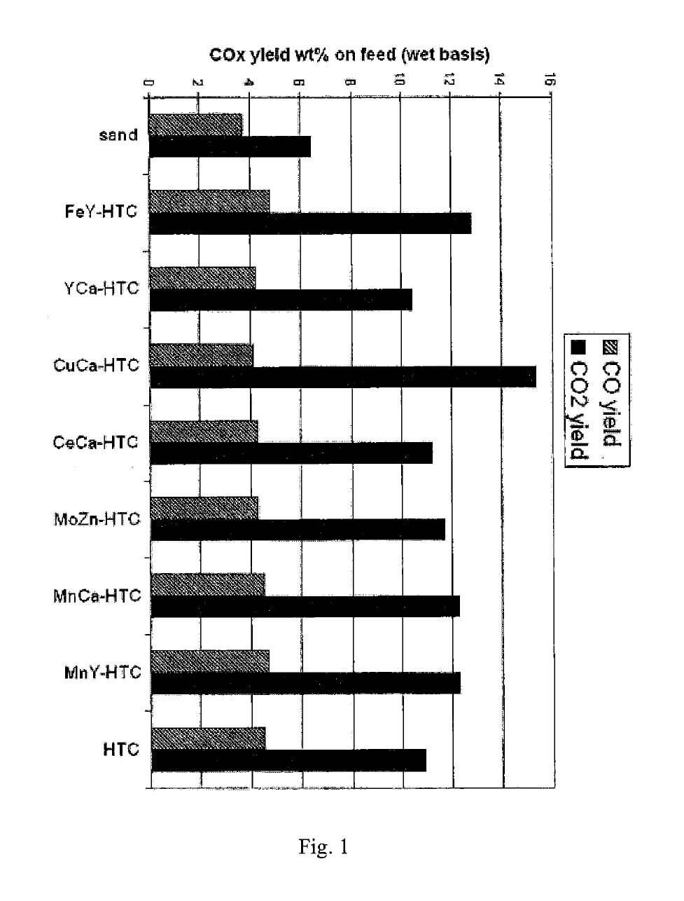

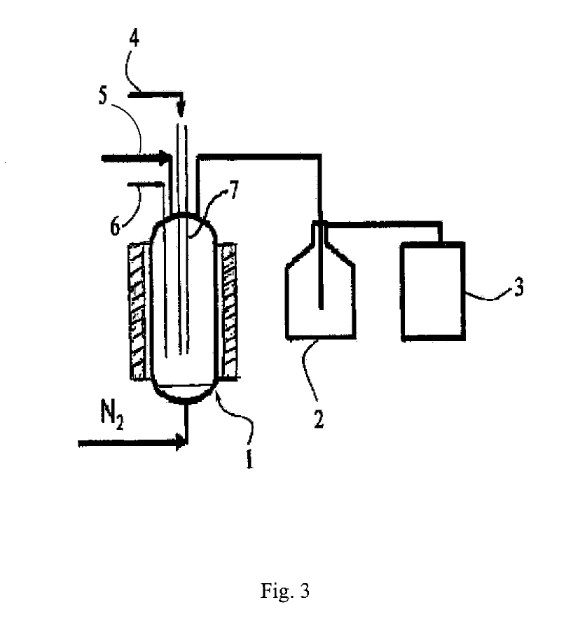

The results shown in FIG. 1 were obtained by use of biomass deoxygenation experiments in which 3 grams of particulate untreated lignocellulosic biomass was introduced into the top of a fast pyrolysis fluidized bed reactor (see FIG. 3) with a flow of nitrogen gas. The fluidized bed was composed of a blend of the catalyst (12 grams) and sand (36 grams) in a weight ratio of 25 wt % of bimetallic catalyst of this invention and 75 wt % of sand. The temperature of the fluidized bed was maintained at about 515° C. at substantially atmospheric pressure. Average residence time was less than 30 seconds.

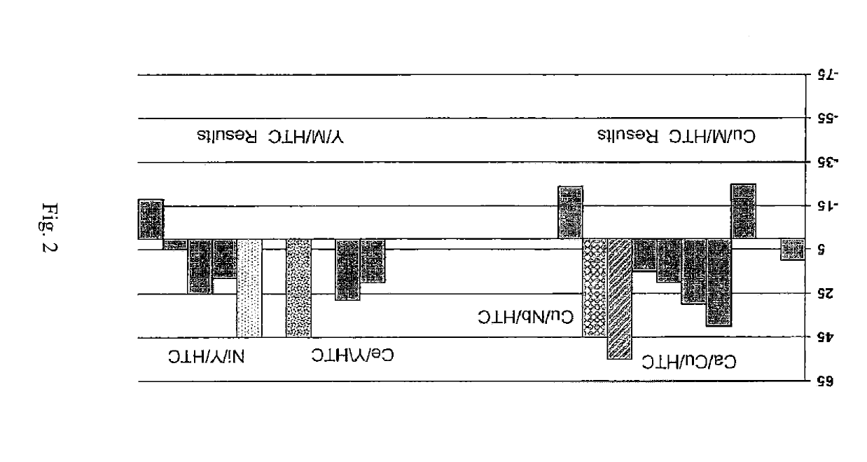

The results shown in FIG. 2 were obtained by use of biomass deoxygenation experiments conducted as follows: Lignocellulosic biomass (10 mg) and 10 mg of bimetallic catalysts prepared using Catalyst Preparation Method A for all catalysts reported except the Ca/Nb/HTC catalyst which was prepared by Catalyst Preparation Method B. Each catalyst was prepared to provide a target 1:1 weight ratio of metals. The weight ratio of biomass to catalyst was 1:1 (10 mg each). These mixtures were rapidly heated in a Thermogravimetric Analysis (TGA) cup to 500° C., all in nitrogen (N₂) at a flow rate of 80 mL/min. Formed pyrolysis vapors were passed through a Fourier Transform Infrared (FTIR) spectroscope cell (volume 15 mL, with KBr windows heated at 150° C.) via tubing traced at 120° C. and FTIR spectra were subsequently recorded: 1 spectrum/20 second intervals (consisting of 5 scans, with 0.5 cm⁻¹ resolution. All reported spectra were corrected for biomass content. After normalization to biomass amount, integral peak areas were compared for specific vibrations in the range 2244-2142 cm⁻¹ specific for C═O vibrations in carbon monoxide, in the range of 2392-2258 cm⁻¹ specific for C═O vibration in carbon dioxide, and in the range of 3856-3853 cm⁻¹ specific for O—H vibration in formed water molecules.

In FIG. 3, a side view in section of a preferred semi-adiabatic fluid bed performance test apparatus is shown. The apparatus includes a reactor 1, a product receiver 2, and a gas bag 3. The reactor 1 has a biomass feed line 4, a heat carrier feed line 5, a thermocouple 6, a dipleg 7, and a nitrogen gas (N₂) inlet.

The pyrolysis gases are analyzed using gas chromatographic methods and the yields of CO and CO₂ are quantified as wt % on feed (wet basis). The liquid (pyrolysis oil) is homogenized by dilution with tetrahydrofuran (THF). The homogenized liquid is analyzed for water content and acidity. The total water yield found in the pyrolysis oil (corrected for THF dilution) is determined by standard Karl-Fischer titration and reported as wt % based on feed (wet basis). The acidity is reported as mg KOH per gram of liquid product at the equivalence point of the titration curve.

The oxygen removal (from the biomass feed) achieved by such a pyrolysis experiment is expressed in the following way:

$${O}_{removal} = \frac{{X}_{CO} \cdot {M}_{O} / {M}_{CO} + {X}_{CO 2} \cdot 2 {M}_{O} / {M}_{CO 2} + {X}_{H 2 O} \cdot {M}_{O} / {M}_{H 2 O}}{{O}_{feed} / 100 \%}$$

### Wherein:

Oᵣₑₘₒᵥₐₗ is wt % of oxygen removed (wt % based on oxygen in the feed)
M_{O}: molar mass of O=15.999 (g/mol))
X_{CO}: yield of CO (wt % on feed)
M_{CO}: molar mass of CO=28.01 (g/mol)
X_{CO2}: yield of CO₂ (wt % on feed)
M_{CO2}: molar mass of CO₂=44.01 (g/mol)
X_{H2O}: yield of H₂O (wt % on feed)
M_{H2O}: molar mass of H₂O =18.02 (g/mol)
O_{feed}: oxygen content in the biomass fed (wt %), which is 49 wt % for the lignocellulosic feed.

The following Examples illustrate various individual embodiments of this invention. These Examples are not intended to limit the invention to only the embodiments described in these Examples. In these Examples, the term HTC refers to a hydrotalcite or hydrotalcite-like compound in which the metals of the two hydroxides are Mg and Al. Such HTC has been impregnated in one or two steps with two different additive metal compounds followed by one or two calcinations depending on the preparation method used. Using Ca and Cu as an example of the metals of the impregnating compounds used, the final calcined product from the impregnation of the HTC with this pair of additive metal compounds is referred to as Ca/Cu/HTC even though the actual chemical structure typically involves oxides, with perhaps some free metal. In all cases the catalyst synthesis used the impregnating compounds in respective amounts targeted to provide the metals in a 1:1 weight ratio.

### EXAMPLES 1-7

Using Method C of catalyst preparation, seven different bimetallic catalysts of this invention were prepared each using Mg/Al/HTC and aqueous solutions of two different water-soluble metal salts, in quantities to produce bimetallic catalysts of this invention. The HTC used had been previously calcined for 1 hour at 550° C. and kept in a desiccator to avoid interaction with moisture and CO₂. The impregnations were conducted using the well-known incipient wetness method with nitrate, ammonium, and/or oxalate salts of the selected pair of added metals. During the calcinations at 600° C. in air or free oxygen-containing inert gas referred to above, the metal salts are transformed to metal oxides although the presence of some of one or both of the free metals cannot be completely excluded. After the impregnated or doped HTC has been calcined and activated by hydration, it was kept under inert conditions such as in a desiccator so as to avoid interaction with moisture and gases such as CO₂. The seven calcined catalysts were then individually evaluated for performance in the bench scale pyrolysis apparatus schematically depicted in FIG. 3. In all of the individual pyrolysis runs, 3 grams of biomass at room temperature were fed into the top of the fluidized catalyst bed preheated to 515° C. The fluidized bed was made up of 12 grams of the bimetallic catalyst of this invention together with 36 grams of sand. A 3 bar nitrogen-purge was used to effect introduction of the solid feed into the fluidized bed via a feed dipleg. After a fast pyrolysis residence time of less than 30 seconds, the fluidized bed was stripped with nitrogen. During the operation, the liquid product was condensed and collected into a product receiver equipped with a cold trap. The pyrolysis gases and nitrogen were collected in a gas bag. The pyrolysis gases were analyzed using gas chromatographic methods. The liquid products were submitted for acidity, water determination, and FTIR or GC-MS analysis. Spent catalyst was analyzed for coke by burning the catalyst. Coke amount measured actually represented a sum of both coke on the catalyst and char (unconverted biomass). As controls, a run was made using sand alone, and another run was made using calcined HTC alone.

Further details concerning Examples 1-7 are summarized in Table 1. The amounts of metals in the catalyst were determined by use of the Inductively Coupled Plasma (ICP) technique.

TABLE 1

| | | Amounts of Metals in the | Yield of CO | Yield of CO₂ |
|---|---|---|---|---|
| | Catalyst | Catalyst from the Metal Pairs | wt % on feed | wt % on feed |
| Example | Component(s) | Used in Making Them | (wet basis) | (wet basis) |
| Control | 100% Sand | — | 3.7 | 6.4 |
| Example 1 | 25% Fe/Y/HTC | 3.7 wt % Fe & 4.1 wt % Y | 4.8 | 12.8 |
| | & 75% Sand | | | |
| Example 2 | 25% Ca/Y/HTC | 4.7 wt % Ca & 4.4 wt % Y | 4.2 | 10.4 |
| | & 75% Sand | | | |
| Example 3 | 25% Ca/Cu/HTC | 5.3 wt % Ca & 4.8 wt % Cu | 4.1 | 15.3 |
| | & 75% Sand | | | |
| Example 4 | 25% Ca/Ce/HTC | 4.6 wt % Ca & 4.5 wt % Ce | 4.3 | 11.2 |
| | & 75% Sand | | | |
| Example 5 | 25% Mo/Zn/HTC | 6.2 wt % Mo & 5.8 wt % Zn | 4.3 | 11.7 |
| | & 75% Sand | | | |
| Example 6 | 25% Ca/Mn/HTC | 4.2 wt % Ca & 3.9 wt % Mn | 4.5 | 12.3 |
| | & 75% Sand | | | |
| Example 7 | 25% Mn/Y/HTC | 4.1 wt % Mn & 4.2 wt % Y | 4.7 | 12.3 |
| | & 75% Sand | | | |
| Control | 100% HTC | — | 4.5 | 10.9 |

It is interesting to note that when tested under the same conditions, zeolite ZSM-5 gave a COₓ (where x is usually 1 or 2) distribution of 10.2 wt % (wet basis) CO and 8.7 wt % CO₂ (wet basis). Thus, this well-known and extensively tested zeolite catalyst gave a COₓ distribution containing a major amount of the toxic carbon monoxide. In sharp contrast, the practice of this invention enables the formation of COₓ distributions containing a major amount of carbon dioxide.

### EXAMPLES 8-11

Using Catalyst Preparation Method A or Catalysts Preparation Method B, four different bimetallic catalysts of this invention were prepared each using Mg/Al/HTC and aqueous solutions of two different water-soluble metal salts, in quantities to produce bimetallic catalysts of this invention. These catalysts were Ca/Cu/HTC, Ce/Y/HTC, Cu/Nb/HTC, and Ni/Y/HTC. The additive metal salts used in making the catalysts, and the weight percentages and atomic ratios of the metal pairs used in making the catalysts are given in Table 2. The four calcined catalysts were then individually evaluated for performance. In these operations, biomass deoxygenation experiments conducted as follows: Lignocellulosic biomass (10 mg) and 10 mg of bimetallic catalysts prepared using Catalyst Preparation Method A for all catalysts reported except the Ca/Nb/HTC catalyst which was prepared by Catalyst Preparation Method B. Each catalyst was prepared to provide a target 1:1 weight ratio of metals. The weight ratio of biomass to catalyst was 1:1. These mixtures were rapidly heated in a Thermogravimetric Analysis (TGA) cup to 500° C., all in nitrogen (N₂) at a rate of 80 mL/min. Formed pyrolysis vapors were passed through a Fourier Transform Infrared (FTIR) spectroscope cell (volume 15 mL, with KBr windows heated at 150° C.) via tubing traced at 120° C. and FTIR spectra were subsequently recorded: 1 spectrum/20 second intervals (consisting of 5 scans, with 0.5 cm⁻¹ resolution. All reported spectra were corrected for biomass content. After normalization to biomass amount, the integral peak areas shown in Table 2 were compared for specific vibrations in the range of 3856-3853 cm⁻¹ specific for O—H vibration in formed water molecules. Also, 13 other biomass deoxygenation experiments were conducted in the same manner using metals other than the metals of the four above bimetallic catalysts of this invention. In one group, 9 tests including Ca/Cu/HTC and Cu/Nb/HTC of the present invention and 7 other copper bimetallic catalysts not of this invention were performed. The 7 bimetallic catalysts not of this invention are represented by the formula Cu/M/HTC, where M is each of 7 different metals other than calcium and niobium, one of these other metals being an alkali metal (Li). In the other group, 8 tests including Ce/Y/HTC and Ni/Y/HTC of the present invention were performed in the same manner. In this group, the 6 bimetallic catalysts not of this invention are represented by the formula Y/M/HTC, where M is each of 6 different metals other than cerium and nickel, one of these other metals being an alkali metal (Li).

Further details concerning Examples 8-11 are summarized in Table 2.

TABLE 2

| | | | Targeted Weight | Qualitative |
|---|---|---|---|---|
| | | Additive Metal | Ratios of the Metal | Water |
| | Catalyst | Salts Used in | Pairs Used in | Removed from |
| Example | Components | Making the Catalyst | Making the Catalyst | the Biomass |
| Example 8 | Ca/Cu/HTC | Ca(NO₃)₂•4H₂O & | 1:1 | 51 |
| | | Cu(NO₃)₂•3H₂O | | |
| Example 9 | Ce/Y/HTC | Ce(NO₃)₃•6H₂O & | 1:1 | 45 |
| | | Y(NO₃)₃•6H₂O | | |
| Example 10 | Cu/Nb/HTC | Cu(NO₃)₂•3H₂O & | 1:1 | 45 |
| | | (NH₄)NbO(C₂O₄)₂•nH₂O | | |
| Example 11 | Ni/Y/HTC | Ni(NO₃)₂•6H₂O & | 1:1 | 45 |
| | | Y(NO₃)₃•6H₂O | | |

### EXAMPLES 12-13

Using Catalyst Preparation Method A, two different bimetallic catalysts of this invention were prepared each using pre-calcined Mg/Al/HTC and aqueous solutions of two different water-soluble metal salts, in quantities to produce bimetallic catalysts of this invention. These catalysts were Ce/Fe/HTC and Ce/Ni/HTC. The additive metal salts used in making the catalysts, and the weight percentages and atomic ratios of the metal pairs used in making the catalysts are given in Table 3. The two calcined catalysts were then individually evaluated for performance. In these operations, biomass deoxygenation experiments conducted as follows: Lignocellulosic biomass (10 mg) and 10 mg of bimetallic catalysts prepared using Catalyst Preparation Method A for both catalysts. Each catalyst was prepared to provide a target 1:1 weight ratio of metals. The weight ratio of biomass to catalyst was 1:1. These mixtures were subjected to the same testing procedure as used and described in Examples 8-11 except that the integral peak areas shown in Table 3 were compared for specific vibrations in the range of 2392-2258 cm⁻¹ specific for C═O vibration in carbon dioxide.

TABLE 3

| | | | Targeted Weight | Qualitative |
|---|---|---|---|---|
| | | Additive Metal | Ratios of the Metal | amount of CO₂ |
| | Catalyst | Salts Used in | Pairs Used in | Produced from |
| Example | Components | Making the Catalyst | Making the Catalyst | the Biomass |
| Example 12 | Ce/Fe/HTC | Ce(NO₃)₃•6H₂O & | 1:1 | 92 |
| | | Fe(NO₃)₃•9H₂O | | |
| Example 13 | Ce/Ni/HTC | Ce(NO₃)₃•6H₂O & | 1:1 | 78 |
| | | Ni(NO₃)₂•6H₂O | | |

### EXAMPLES 14-15

Using Catalyst Preparation Method C, two different bimetallic catalysts of this invention were prepared each using pre-calcined Mg/Al/HTC and aqueous solutions of two different water-soluble metal salts, in quantities to produce bimetallic catalysts of this invention. The HTC used had been previously calcined for 1 hour at 550° C. and kept in a desiccator to avoid interaction with moisture and CO₂. The impregnations were conducted using the well-known incipient wetness method with nitrate, ammonium, and/or oxalate salts of the selected pair of added metals. The two calcined catalysts were then individually evaluated for performance in the bench scale pyrolysis apparatus in the same way, in the same test system and under the same conditions as used in Examples 1-7.

This catalyst was utilized under fast pyrolysis conditions at 515° C. using the same biomass as used in the experiments described above with reference to FIGS. 1-3. The materials used in this operation were: a mixture of 75 wt % sand as a heat transfer agent and 25 wt % of the Fe/Ca/HTC catalyst to which the biomass sample was fed in the absence of air, molecular oxygen, molecular hydrogen, and liquid solvent or diluent. The quantities of these materials used were 36 grams of sand, 12 grams of the Fe/Ca/HTC catalyst, and 3 grams of biomass. This fast pyrolysis test procedure involved the following operations.

Table 4 summarizes the characteristics of the products formed in the above fast pyrolysis procedure in comparison to the products formed using the same quantity of the same HTC without any additional catalytic components.

TABLE 4

| Catalyst | Units of | | | | |
|---|---|---|---|---|---|
| Performance | Performance | Sand | HTC fresh | Ca/Fe/HTC | Ca/Zn/HTC |
| Coke yield | wt % on feed (wb)* | 12.3 | 26.9 | 29.6 | 27.7 |
| Water yield | wt % on feed (wb) | 21.3 | 26.1 | 28.0 | 27.5 |
| TAN^{†} | mg KOH/g liquid | 109 | 95 | 74 | 72 |
| | product | | | | |
| CO yield | wt % on feed (wb) | 3.7 | 4.5 | 4.9 | 4.4 |
| CO₂ yield | wt % on feed (wb) | 6.4 | 10.9 | 14.2 | 13.3 |
| O removal (by | wt % on O-feed (wb) | 52.3 | 68.9 | 77.7 | 74.7 |
| H₂O, CO, and CO₂) | | | | | |

*(wb) stands for wet basis.
^{†}TAN stands for total acid number, which is defined as the amount of KOH (in mg) needed to neutralize 1 g of the substance tested.

It will be noted from Table 4 that the Fe/Ca/HTC catalyst gave much greater yields of CO, CO₂, and oxygen removal as compared to the plain HTC material. It will also be seen that the acidity of the bio-oil formed in the process were significantly lower when using the Fe/Ca/HTC catalyst.

Additional embodiments of the invention include:

BA) A method for producing one or more fluid hydrocarbon products from a solid state biomass material, said method comprising:
(I) forming a mixture by bringing into contact under agitation in a pyrolysis reactor:
   A) particulate or subdivided solid state biomass material which is untreated except for optional drying and/or size reduction;
   B) a rehydrated impregnated or doped solid state calcined pyrolysis catalyst which as charged to the reactor is a calcined product comprising, consisting essentially of, or consisting of, at least one calcined hydrotalcite or hydrotalcite-like compound, layered dihydroxide, anionic clay, or a mixture of any two or more of them, impregnated or carrying (1) a single pair of metals, (2) at least one oxide of each of a single pair of said metals, or (3) a combination of (a) at least one oxide of one or both of a single pair of metals and (b) at least one free metal of one or both of a single pair of metals, wherein said calcined product is formed by calcining at least one pre-calcined hydrotalcite or hydrotalcite-like compound, layered dihydroxide, anionic clay, or a mixture of any two or more of them, that has been impregnated by or carries salts of said pair of metals, in the presence of free oxygen (e.g., air or a mixture of oxygen and at least one inert gas selected from nitrogen, neon, argon, or krypton), and wherein the single pair of metals of (1), (2), or (3) is selected from the following groups: Ca & Ce, Ca & Cu, Ca & Fe, Ca & Mn, Ca & Y, Ca & Zn, Ce & Fe, Ce & Ni, Ce & Y, Cu & Nb, Fe & Y, Mc & Zn, Mn & Y, Ni & Y; and
   C) a solid state particulate heat carrier;
(II) fast or flash pyrolyzing at one or more temperatures above about 500° C. at least a portion of said mixture of (I) within the pyrolysis reactor and without any added air, added molecular oxygen, added molecular hydrogen, or added liquid diluent or carrier, such as water, to thereby form fluid pyrolysis products.

BB) A method as in BA), wherein said single pair of metals of (1), (2), or (3) is selected from Ca & Ce, Ca & Cu, Ca & Fe, Ca & Mn, Ca & Y, Ca & Zn, Fe & Y, Mo & Zn, and Mn & Y.

BC) A method as in BB), wherein said single pair of metals of (1), (2), or (3) is selected from Ca & Cu, and Ca & Fe.

BD) A method as in any of BA)-BC), wherein said pre-calcined hydrotalcite or hydrotalcite-like compound, layered dihydroxide, anionic clay, or a mixture of any two or more of them, has a metal content of magnesium and aluminum.

BE) A method as in any of BA)- BC), wherein said fast or flash pyrolysis is conducted at a temperature from above 500° C. to about 650° C. at substantially atmospheric pressure, wherein the biomass material is charged into the pyrolysis reactor with an inert anhydrous carrier gas, preferably nitrogen, argon, neon, or krypton, or a mixture of any two or more thereof, wherein said solid state particulate heat carrier is sand, wherein said calcined pyrolysis catalyst as charged to the reactor has average particle size of about 40 to about 400 microns, and preferably in the range of about 50 to about 150 microns, wherein said calcined pyrolysis catalyst as charged into the pyrolysis reactor has been activated by rehydration, and wherein the method is conducted with an average residence time within the pyrolysis reactor is 30 seconds or less, preferably 20 seconds or less, or more preferably 10 seconds or less.

BF) A method as in any of BA)- BC), wherein said temperature is in the range of about 510° C. to about 575° C.

CA) A solid state pyrolysis catalyst composition comprising, consisting essentially of, or consisting of a calcined product formed from at least one pre-calcined hydrotalcite or hydrotalcite-like compound, layered dihydroxide, anionic clay, or a mixture of any two or more of them, which has been impregnated or doped with salts, preferably inorganic salts, of a pair of metals selected from: Ca & Ce, Ca & Cu, Ca & Fe, Ca & Mn, Ca & Y, Ca & Zn, Ce & Fe, Ce & Ni, Ce & Y, Cu & Nb, Fe & Y, Mo & Zn, Mn & Y, and Ni & Y and calcined in the presence of free oxygen (e.g., air or a mixture of oxygen and at least one inert gas selected from nitrogen, neon, argon, or krypton) at one or more elevated temperatures after drying so that one or more oxides of at least a portion of one or both of the pair of metals is converted into oxides.

CB) A catalyst composition as in CA), wherein said pair of metals is selected from Ca & Ce, Ca & Cu, Ca & Fe, Ca & Mn, Ca & Y, Ca & Zn, Fe & Y, Mo & Zn, and Mn & Y.

CC) A catalyst composition as in CB), wherein said pair of metals is selected from Ca & Cu, and Ca & Fe.

CD) A catalyst composition as in any of CA)- CC), wherein said pre-calcined hydrotalcite or hydrotalcite-like compound, layered dihydroxide, anionic clay, or a mixture of any two or more of them, has a metal content of magnesium and aluminum.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure.

The invention may comprise, consist, or consist essentially of the materials and/or procedures recited herein.

Except as may be expressly otherwise indicated, the article “a” or “an” if and as used herein is not intended to limit, and should not be construed as limiting, a claim to a single element to which the article refers. Rather, the article “a” or “an” if and as used herein is intended to cover one or more such elements, unless the text expressly indicates otherwise.

This invention is susceptible to considerable variation in its practice. Therefore the foregoing description is not intended to limit, and should not be construed as limiting, the invention to only the particular exemplifications presented hereinabove.

That which is claimed is:

1. A method for producing one or more fluid hydrocarbon products from a solid state biomass material, said method comprising:
(I) forming a mixture by bringing into contact under agitation in a pyrolysis reactor:
A) particulate or subdivided solid state biomass material which is untreated except for optional drying and/or size reduction;
B) a rehydrated impregnated or doped solid state calcined pyrolysis catalyst which as charged to the reactor is a calcined product comprising, consisting essentially of, or consisting of, at least one calcined hydrotalcite or hydrotalcite-like compound, layered dihydroxide, anionic clay, or a mixture of any two or more of them, impregnated or carrying (1) a single pair of metals, (2) at least one oxide of each of a single pair of said metals, or (3) a combination of (a) at least one oxide of one or both of a single pair of metals and (b) at least one free metal of one or both of a single pair of metals, wherein said calcined product is formed by calcining at least one pre-calcined hydrotalcite or hydrotalcite-like compound, layered dihydroxide, anionic clay, or a mixture of any two or more of them, that has been impregnated by or carries salts of said pair of metals, in the presence of free oxygen, and wherein the single pair of metals of (1), (2), or (3) is selected from the following groups: Ca & Ce, Ca & Cu, Ca & Fe, Ca & Mn, Ca & Y, Ca & Zn, Ce & Fe, Ce & Ni, Ce & Y, Cu & Nb, Fe & Y, Mo & Zn, Mn & Y, Ni & Y; and
C) a solid state particulate heat carrier;
(II) fast or flash pyrolyzing at one or more temperatures above about 500° C. at least a portion of said mixture of (I) within the pyrolysis reactor and without any added air, added molecular oxygen, added molecular hydrogen, or added liquid diluent or carrier, to thereby form fluid pyrolysis products.

2. A method as in claim 1, wherein said single pair of metals of (1), (2), or (3) is selected from Ca & Ce, Ca & Cu, Ca & Fe, Ca & Mn, Ca & Y, Ca & Zn, Fe & Y, Mo & Zn, and Mn & Y.

3. A method as in claim 2, wherein said single pair of metals of (1), (2), or (3) is selected from Ca & Cu, and Ca & Fe.

4. A method as in claim 1, wherein said pre-calcined hydrotalcite or hydrotalcite-like compound, layered dihydroxide, anionic clay, or a mixture of any two or more of them, has a metal content of magnesium and aluminum.

5. A method as in claim 1, wherein said fast or flash pyrolysis is conducted at one or more temperatures in the range of from above 500° C. to about 650° C. at substantially atmospheric pressure, wherein the biomass material is charged into the pyrolysis reactor with an inert anhydrous carrier gas, wherein said solid state particulate heat carrier is sand, wherein said calcined pyrolysis catalyst as charged to the reactor has average particle size of about 40 to about 400 microns, wherein said calcined pyrolysis catalyst as charged into the pyrolysis reactor has been activated by rehydration, and wherein the method is conducted with an average residence time within the pyrolysis reactor is 30 seconds or less.

6. A method as in claim 1, wherein said pyrolysis is conducted at one or more temperatures in the range of about 510° C. to about 575° C.

7. A solid state pyrolysis catalyst composition comprising, consisting essentially of, or consisting of a calcined product formed from at least one pre-calcined hydrotalcite or hydrotalcite-like compound, layered dihydroxide, anionic clay, or a mixture of any two or more of them, which has been impregnated or doped with salts, of a pair of metals selected from: Ca & Ce, Ca & Cu, Ca & Fe, Ca & Mn, Ca & Y, Ca & Zn, Ce & Fe, Ce & Ni, Ce & Y, Cu & Nb, Fe & Y, Mo & Zn, Mn & Y, and Ni & Y and calcined in the presence of free oxygen at one or more elevated temperatures after drying so that one or more oxides of at least a portion of one or both of the pair of metals is converted into oxides.

8. A catalyst composition as in claim 7, wherein said pair of metals is selected from Ca & Ce, Ca & Cu, Ca & Fe, Ca & Mn, Ca & Y, Ca & Zn, Fe & Y, Mo & Zn, and Mn & Y.

9. A catalyst composition as in claim 8, wherein said pair of metals is selected from Ca & Cu, and Ca & Fe.

10. A catalyst composition as in claim 7, wherein said pre-calcined hydrotalcite or hydrotalcite-like compound, layered dihydroxide, anionic clay, or a mixture of any two or more of them, has a metal content of magnesium and aluminum.

11. A method of preparing a catalyst composition adapted for producing pyrolysis products without any added air, molecular oxygen, molecular hydrogen, or liquid, from particulate or subdivided solid state biomass material which is untreated except for optional drying and/or size reduction, which method comprises:
A) producing or providing one or more solutions which taken individually provides or which taken collectively provide a dissolved pair of metals, the solution(s) comprising solvent(s) which can be the same or different, and are vaporizable solvent(s), and the pair of dissolved metals of said one or more solutions is selected from the group consisting of Ca & Ce, Ca & Cu, Ca & Fe, Ca & Mn, Ca & Y, Ca & Zn, Ce & Fe, Ce & Ni, Ce & Y, Cu & Nb, Fe & Y, Mo & Zn, Mn & Y, and Ni & Y; and
B) impregnating a powdery or particulate hydrotalcite or hydrotalcite-like compound, layered dihydroxide, anionic clay, or a mixture of any two or more of them, by incipient wetness using one or more of said solutions of A) above to form a wet mixture, drying the wet mixture to form a product mixture, and then calcining the product mixture in the presence of free oxygen.

12. A method as in claim 11, wherein said pair of metals is selected from Ca & Ce, Ca & Cu, Ca & Fe, Ca & Mn, Ca & Y, Ca & Zn, Fe & Y, Mo & Zn, and Mn & Y.

13. A method as in claim 12, wherein said pair of metals is selected from Ca & Cu, and Ca & Fe.

14. A method as in claim 11, wherein said pre-calcined hydrotalcite or hydrotalcite-like compound, layered dihydroxide, anionic clay, or a mixture of any two or more of them, has a metal content of magnesium and aluminum.

15. A method for converting solid state biomass material into one or more fluid hydrocarbon products, which method comprises introducing particulate or subdivided solid state biomass material which is untreated except for optional drying and/or size reduction into a pyrolysis reactor operating at one or more temperatures above about 500° C. under fast or flash operating conditions, said reactor containing a fluidized mixture of (1) a calcined pyrolysis catalyst which as initially introduced into the reactor was a catalyst composition formed by the method of claims 11, and (2) a solid state particulate heat carrier, wherein the method is conducted without any added air, any added molecular oxygen, any added molecular hydrogen, and/or any added liquid diluent or carrier.

16. A method as in claim 15, wherein said pair of metals is selected from Ca & Ce, Ca & Cu, Ca & Fe, Ca & Mn, Ca & Y, Ca & Zn, Fe & Y, Mo & Zn, and Mn & Y.

17. A method as in claim 16, wherein said pair of metals is selected from Ca & Cu, and Ca & Fe.

18. A method as in claim 15, wherein said pre-calcined hydrotalcite or hydrotalcite-like compound, layered dihydroxide, anionic clay, or a mixture of any two or more of them, has a metal content of magnesium and aluminum.

19. A method as in claim 15, wherein said fast or flash operating conditions include operating the pyrolysis reactor at one or more temperatures in the range of from above 500° C. to about 650° C. at substantially atmospheric pressure, wherein the biomass material is charged into the pyrolysis reactor with an inert anhydrous carrier gas, wherein said a solid state particulate heat carrier is sand, wherein said calcined pyrolysis catalyst as charged to the pyrolysis reactor has average particle size of about 40 to about 400 microns, wherein said calcined pyrolysis catalyst as charged into the pyrolysis reactor has been activated by rehydration, and wherein the method is conducted with an average residence time within the pyrolysis reactor is 30 seconds or less.

20. A method as in claim 15, wherein said pre-calcined hydrotalcite or hydrotalcite-like compound, layered dihydroxide, anionic clay, or a mixture of any two or more of them, has a metal content of magnesium and aluminum, wherein said fast or flash operating conditions include operating the pyrolysis reactor at one or more temperatures in the range of from above 500° C. to about 650° C. at substantially atmospheric pressure, wherein the biomass material is charged into the pyrolysis reactor with an inert anhydrous carrier gas, wherein said a solid state particulate heat carrier is sand, wherein said calcined pyrolysis catalyst as charged to the pyrolysis reactor has average particle size of about 40 to about 400 microns, wherein said calcined pyrolysis catalyst as charged into the pyrolysis reactor has been activated by rehydration, and wherein the method is conducted with an average residence time within the pyrolysis reactor is 30 seconds or less.

21. A catalyst composition as in claim 8, wherein said pre-calcined hydrotalcite or hydrotalcite-like compound, layered dihydroxide, anionic clay, or a mixture of any two or more of them, has a metal content of magnesium and aluminum.

22. A catalyst composition as in claim 9, wherein said pre-calcined hydrotalcite or hydrotalcite-like compound, layered dihydroxide, anionic clay, or a mixture of any two or more of them, has a metal content of magnesium and aluminum.
